(19) United States
(12) Patent Application Publication
(10) Pub. No.: US 2010/0078894 A1
(43) Pub. Date: Apr. 1, 2010

(54) SEALING APPARATUS OF WAFER CARRIER AND SEALING METHOD THEREOF

(75) Inventor: Pao-Yi Lu, Sansia Township (TW)

Correspondence Address: ROGER H. CHU, 19499 ERIC DRIVE, SARATOGA, CA, 95070, US

(73) Assignee: Gudeng Precision Industrial Co., Ltd., Shulin City (TW)

(21) Appl. No.: 12/242,966

(22) Filed: Oct. 1, 2008

(51) Int. Cl. F16J 15/02; F16J 15/48

(52) U.S. Cl. 277/312; 277/646

(57) ABSTRACT

The present invention discloses a sealing apparatus of a wafer carrier and a sealing method, and the wafer carrier is comprised of a wafer container and a cover, and includes a latch unit for integrally latch the wafer container and the cover. The wafer container has an open distal portion disposed on a surface of wafer container, and the sealing apparatus is installed between the open distal portion and the cover. The sealing apparatus includes an air intake/outtake valve and an air inflation sealing unit coupled to the air intake/outtake valve, and the air intake/outtake valve performs an air inflation to expand the air inflation sealing unit, and the wafer container and the cover are elastically latched after the inflation and the expansion of the air inflation sealing unit to achieve the sealing effect.

### FIELD OF THE INVENTION

The present invention relates to a wafer carrier sealing apparatus, and more particularly to a wafer carrier sealing apparatus and a sealing method that achieve a complete sealing effect.

### BACKGROUND OF THE INVENTION

Wafer fabrication plants require a very high level of cleanliness to avoid particle effect from affecting the normal operations of the wafer fabrication process and maintain a desired yield rate. In semiconductor fabrication plants, if a trace of particle or airborne molecular impurities in the air is attached onto the semiconductor wafer or other objects during the transportation or storage period, the yield rate of the semiconductor wafers or substrates of masks will be lowered, and the situation becomes increasingly more signification as the degree of integration increases. Therefore, there is a strict requirement for high cleanliness, and the level of cleanliness not aims at the particles only, but also aims at the airborne molecular impurities. Maintaining the air in the wafer fabrication plant at a high level of cleanliness incurs a high capital and a high operating cost, and thus it is an important subject to develop a low-cost manufacturing process.

To provide a clean space for carrying substrates during their transportation or storage, designers and manufacturers developed a clean wafer carrier with a standard mechanical interface (SMIF) technology for carrying the substrates without maintaining clean air for the whole wafer fabrication plant to lower the manufacturing cost, and the major benefit of such technology is to greatly reduce the requirement for a large-area clean room in a wafer fabrication plant, and also lower the cost for the clean room and related equipments for maintaining a high level of clean air. Since this technology can substantially reduce the investment scale and operating cost of the wafer fabrication plant, therefore most of the productions in the 8-inch wafer plants are equipped with the SMIF clean wafer carrier for the transpiration, and thus Taiwan becomes one of the major markets for the SMIF equipments.

As science and technology advance, 12-inch wafer plants are built, and there is a need for a mini wafer carrier for the transportation of fabricated wafers, and the mini wafer carrier becomes a standard equipment of the 12-inch wafer plants. Since the 12-inch wafer is larger than the 8-inch wafer, the wafer, the specifications of wafer carriers and load port must be taken into consideration, such that a robot arm can access the wafers successfully, and a new specification called Front Opening Unified Pod (FOUP) is established for wafer carriers.

Regardless of SMIF or FOUP, the main purpose is to seal the interior of wafers in order to avoid the contact with particle or airborne molecular impurities during the transportation and maintain the required level of cleanliness of the wafers. Most of the SMIF or the FOUP are mainly composed of a wafer container and a cover, wherein a sealing component is installed at an open portion of the wafer container and generally made of a polyolefin thermoplastic elastomer, a polyester thermoplastic elastomer or a rubber material. If the cover is closed and latched with the wafer container, the cover will cover the open portion, and the sealing component will be compressed by forces such that the sealing component will be attached integrally with the cover to achieve the sealing effect in the SMIF or FOUP. Since the sealing component is made of a thermoplastic elastomer or a rubber material, the sealing component will become deformed or elastically fatigue after a long time of use, and the sealing effect will become poor. As a result, particle or airborne molecular impurities may enter into the SMIF or FOUP to contaminate the wafer in the SMIF or FOUP. Obviously, the prior art requires further improvements.

It is an important subject for related manufacturers or designers to develop a SMIF or a FOUP sealing apparatus and provide a sealing method to achieve the required sealing effect.

### BRIEF SUMMARY OF THE INVENTION

Therefore, it is a primary objective of the present invention to provide a sealing apparatus of a wafer carrier and a sealing method to achieve the required sealing effect.

To achieve the foregoing objective, the present invention provides a sealing apparatus of a wafer carrier, and the wafer carrier is comprised of a wafer container and a cover, wherein a latch unit is provided for integrally latching the wafer container and the cover, and an open distal portion is disposed on a surface of the wafer container, and the sealing apparatus is installed between the open distal portion and the cover, and the sealing apparatus comprises an air intake/outtake valve and an air inflation sealing unit coupled to the air intake/outtake valve, and the air intake/outtake valve performs an inflation to expand the air inflation sealing unit, and after the air inflation sealing unit is inflated and expanded for latching the wafer container and the cover, the required sealing effect can be achieved.

The present invention also discloses a sealing method of a wafer carrier, and the wafer carrier is comprised of a wafer container and a cover, wherein a latch unit is provided for integrally latching the wafer container and the cover, and an open distal portion is disposed on a surface of the wafer container, and the sealing apparatus is installed between the open distal portion and the cover, and the sealing apparatus comprises an air intake/outtake valve and an air inflation sealing unit coupled to the air intake/outtake valve, and the sealing method comprises the steps of: integrally latching the wafer container and the cover through the latch unit; and inflating the air inflation sealing unit through the air intake/outtake valve.

The technical characteristics of the present invention will become apparent from the detailed description taken with the accompanying drawings as follows:

### BRIEF DESCRIPTION OF THE DRAWINGS

FIG. 1 is an exploded view of a sealing apparatus of the present invention;

FIG. 2 is a schematic view of a sealing apparatus of the present invention;

FIG. 3 is a perspective view of the sealing apparatus of the present invention;

FIG. 4 is a schematic view of a preferred embodiment of the present invention;

FIG. 5 is a schematic view of operating an air intake/outtake valve of the present invention;

FIG. 6 is a schematic view of operating an air intake/outtake valve of the present invention; and

FIG. 7 is a schematic view of operating the present invention.

### DETAILED DESCRIPTION

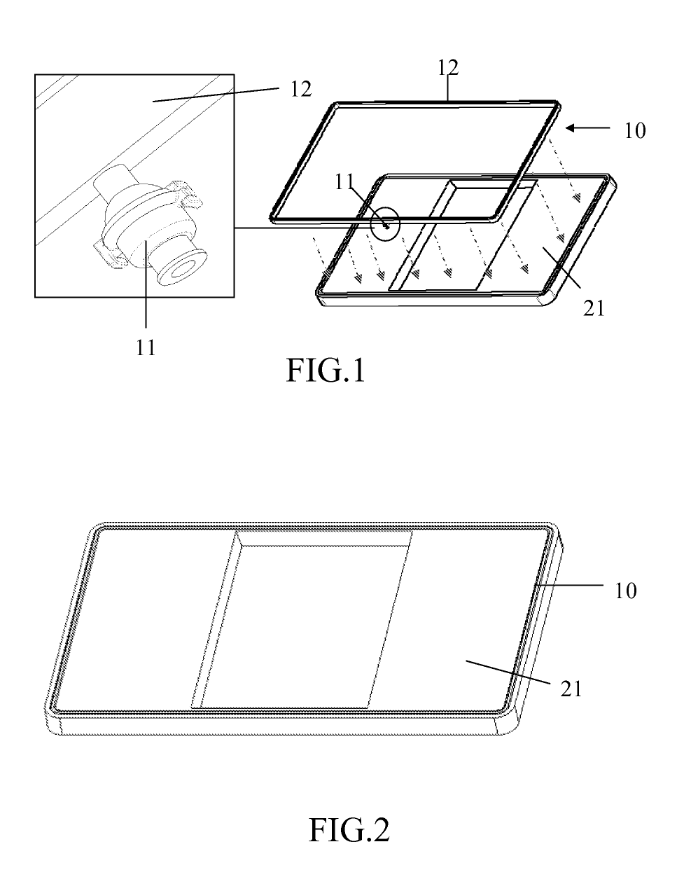

With reference to FIGS. 1 and 2 for an exploded view and a perspective view of a sealing apparatus of a wafer carrier and its sealing method in accordance with the present invention respectively, the sealing apparatus 10 is comprised of an air intake/outtake valve 11 and an air inflation sealing unit 12 coupled to the air intake/outtake valve 11, and the sealing apparatus 10 is fixed at an edge of an internal surface of a cover 21. The air intake/outtake valve 11 performs an inflation to expand the air inflation sealing unit 12 or outtakes the air after the air inflation sealing unit 12 is inflated and expanded according to a user's need. In addition, the air inflation sealing unit 12 is made of a polyolefin thermoplastic elastomer, a polyester thermoplastic elastomer or a rubber material.

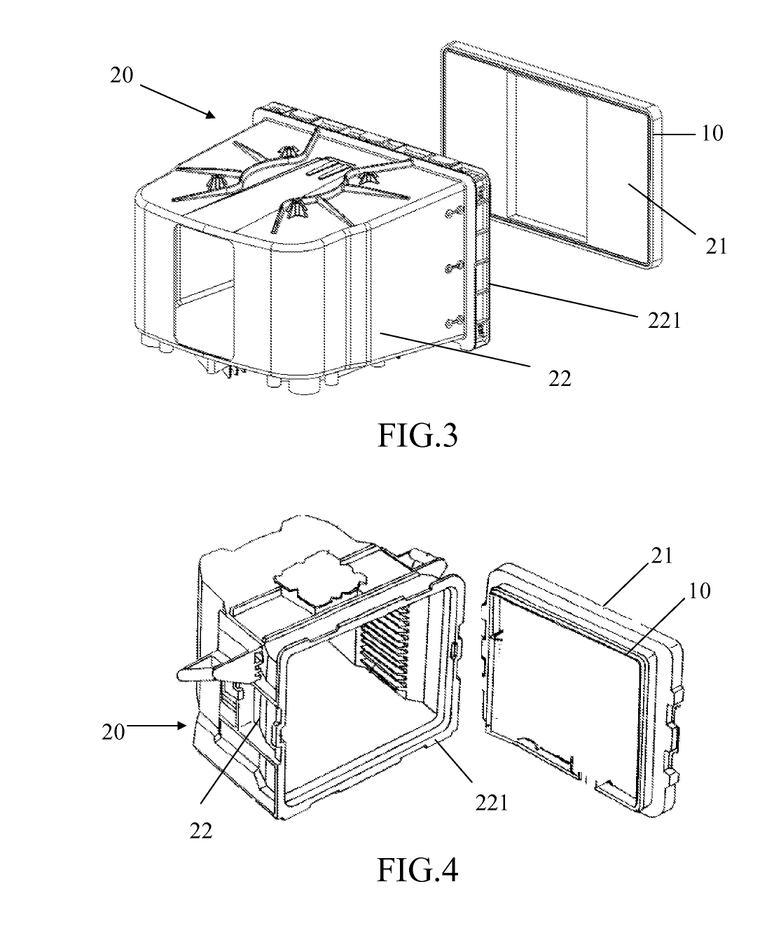

With reference to FIGS. 3 and 4 for a preferred embodiment of the present invention, a wafer carrier 20 is comprised of a wafer container 22 and a cover 21, wherein a latch unit (not shown in the figure) disposed between the wafer container 22 and the cover 21 is used for integrally latching the wafer container 22 and the cover 21. An open distal portion 221 is disposed on a surface of the wafer container 22, and the sealing apparatus 10 is installed between the open distal portion 221 and the cover 21. In other words, the sealing apparatus 10 is fixed to an edge of an internal surface of the cover 21 or on the open distal portion 221. In this embodiment, the sealing apparatus 10 is fixed to an edge of an internal surface of the cover 21.

If it is necessary to move a wafer carrier 20 to another place, the air intake/outtake valve 11 is inflated to expand the sealing unit 12, then the wafer container 22 and the cover 21 are integrally engaged by a latch unit (not shown in the figure). Now, the air in the expanded air inflation sealing unit 12 of the sealing apparatus 10 can be used for elastically and closely engaging the open distal portion 221 of the wafer container 22 with the cover 21 to achieve the required sealing effect, such that when the wafer carrier 20 is moved out from a clean room, external particle or airborne molecular impurities will not be in contact with the interior space of the wafer carrier 20.

Since the air inflation sealing unit 12 is made of a polyolefin thermoplastic elastomer, a polyester thermoplastic elastomer or a rubber material, the air inflation sealing unit 12 will become deformed or elastically fatigue after a long time of use, and the internal gas pressure of the air inflation sealing unit 12 will be insufficient and a poor sealing effect will result. Now, the air intake/outtake valve 11 is inflated to expand the air inflation sealing unit 12 again to provide the elasticity of the air for the deformed or elastically fatigue air inflation sealing unit 12 to resume the required sealing effect.

After the use of the wafer carrier 20 is completed, the air intake/outtake valve 11 is outtaked to discharge the air in the air inflation sealing unit 12, such that the air inflation sealing unit 12 returns to its originally deflated state, or the air inflation sealing unit 12 can be prevented from becoming deformed or elastically fatigue after the air inflation sealing unit 12 is situated at an inflated and expanded state for a long time.

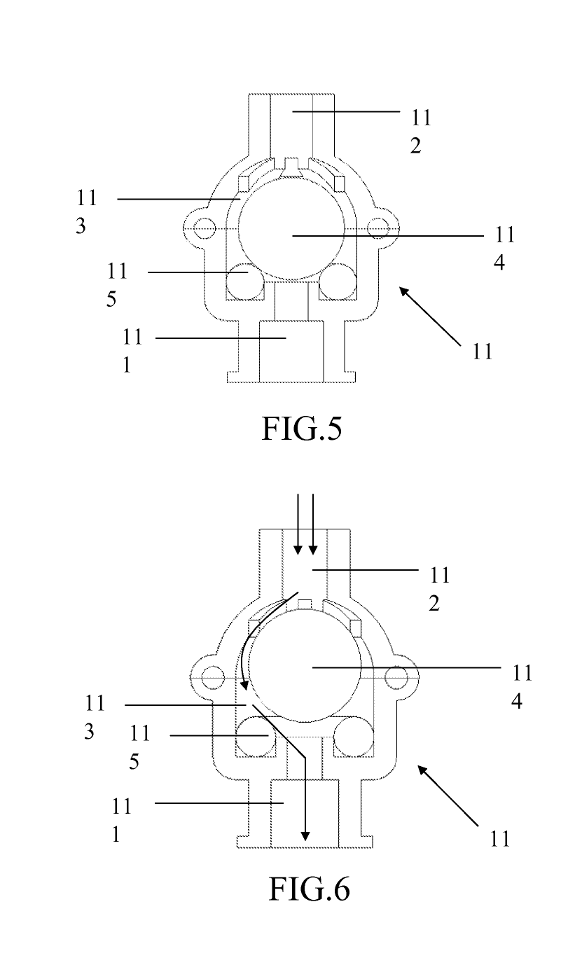

With reference to FIGS. 5 and 6 for the operations of an air intake/outtake valve in accordance with the present invention together with FIG. 1, the air intake/outtake valve 11 of the invention is comprised of a first air intake/outtake passage 111, a second air intake/outtake passage 112 coupled to the air inflation sealing unit 12, a central chamber 113 coupled between the first air intake/outtake passage 111 and the second air intake/outtake passage 112, an O-ring 115 installed in the central chamber 113 and sheathed at a connecting position of the first air intake/outtake passage 111, and a sealing ball 114 installed at the top of the O-ring 115. When the air intake/outtake valve 11 is inflated, external air will push the sealing ball 114 upward through the first air intake/outtake passage 111 to separate the O-ring 115, and the external air can enter into the air inflation sealing unit 12 through the first air intake/outtake passage 111, the central chamber 113 and the second air intake/outtake passage 112 to complete the air inflation.

After the inflation is completed, the internal air pressure of the air inflation sealing unit 12 is greater than the atmospheric pressure, the air in the air inflation sealing unit 12 will be discharged to push the sealing ball 114 against the O-ring 115, such that the central chamber 113 and the first air intake/outtake passage 111 are separated completely from each other, and the air in the air inflation sealing unit 12 will not leak through the first air intake/outtake passage 111, so as to maintain the gaseous elasticity of the air inflation sealing unit 12 and the sealing apparatus 10.

If it is necessary to discharge the air in the air inflation sealing unit 12, a rod shaped object (not shown in the figure) is used for pushing the sealing ball 114 upward through the first air intake/outtake passage 111 to separate the O-ring 115. Now, the central chamber 113 and the first air intake/outtake passage 111 are interconnected, and the air in the air inflation sealing unit 12 will be discharged to the outside through the second air intake/outtake passage 112, the central chamber 113 and the first air intake/outtake passage 111, until the internal air pressure of the air inflation sealing unit 12 is equal to the atmospheric pressure. The operation is very simple and convenient.

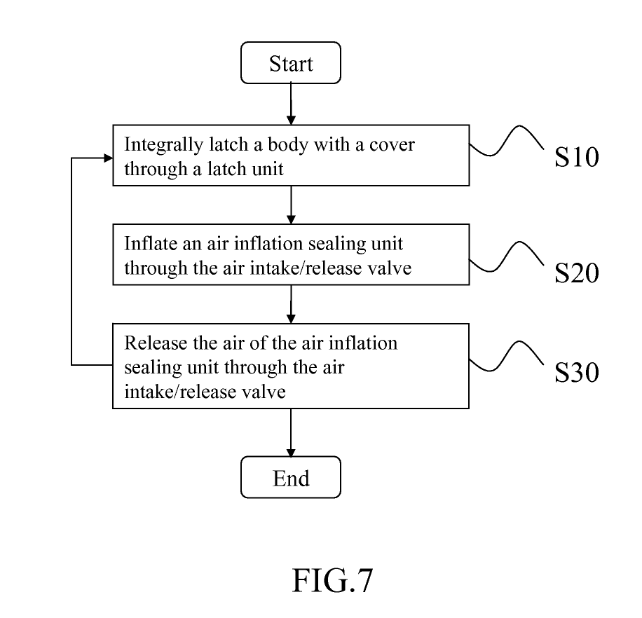

With reference to FIG. 7 for a flow chart of a sealing method of a wafer carrier in accordance with a preferred embodiment of the present invention, the wafer carrier is comprised of a wafer container and a cover, wherein a latch unit disposed between the wafer container and the cover is used for integrally latching the wafer container and the cover, and an open distal portion is disposed on a surface of the wafer container, and the sealing apparatus is installed between the open distal portion and the cover, and the sealing apparatus comprises an air intake/outtake valve and an air inflation sealing unit coupled to the air intake/outtake valve, and the sealing method comprises the steps of: integrally latching the wafer container with the cover by the latch unit (S10), and inflating the air intake/outtake valve to expand the air inflation sealing unit (S20). Now, the air in the expanded air inflation sealing unit of the sealing apparatus can be used for elastically integrating the open distal portion of the wafer container with the cover to achieve the required sealing effect, such that external particle or airborne molecular impurities will not be into the interior of the wafer carrier when the wafer carrier is moved out from the clean room.

After the use of the wafer carrier is completed, the air intake/outtake valve is outtaked to discharge the air in the air inflation sealing unit (S30), so that the air inflation sealing unit can return to its original deflated state, or the air inflation sealing unit can be prevented from becoming deformed or elastically fatigue after a long time of use. Users simply repeat the Step S10 for the next-time use, and the application is very convenient and practical.

While the invention has been described by means of specific embodiments, numerous modifications and variations could be made thereto by those skilled in the art without departing from the scope and spirit of the invention set forth in the claims.

What is claimed is:

1. A sealing apparatus of a wafer carrier, and the wafer carrier being comprised of a wafer container and a cover, and having latch unit disposed between the wafer container and the cover for integrally coupling the wafer container and the cover, and the wafer container having an open distal portion disposed on a surface of the wafer container, and the sealing apparatus being installed between the open distal portion and the cover, and the sealing apparatus comprising:
an air intake/outtake valve; and
an air inflation sealing unit coupled to the air intake/outtake valve, and the air intake/outtake valve performing an inflation to expand the air inflation sealing unit.

2. The sealing apparatus of a wafer carrier of claim 1, wherein the air inflation sealing unit is made of a polyolefin thermoplastic elastomer, a polyester thermoplastic elastomer or a rubber material.

3. The sealing apparatus of a wafer carrier of claim 1, wherein the sealing apparatus is fixed at an edge of an inner surface of the cover.

4. The sealing apparatus of a wafer carrier of claim 1, wherein the sealing apparatus is fixed on the open distal portion.

5. The sealing apparatus of a wafer carrier of claim 1, wherein the air intake/outtake valve comprises a first air intake/outtake passage, a second air intake/outtake passage coupled to the air inflation sealing unit, a central chamber coupled between the first air intake/outtake passage and the second air intake/outtake passage, an O-ring installed in the central chamber and sheathed at a connecting position of the first air intake/outtake passage, and a sealing ball installed at the top of the O-ring.

6. A sealing method of a wafer carrier, and the wafer carrier being comprised of a wafer container and a cover, and having latch unit disposed between the wafer container and the cover for integrally coupling the wafer container and the cover, and the wafer container having an open distal portion disposed on a surface of the wafer container, and the sealing apparatus being installed between the open distal portion and the cover, and the sealing apparatus comprising an air intake/outtake valve and an air inflation sealing unit coupled to the air intake/outtake valve, and the sealing method comprising the steps of:
integrally latching the wafer container and the cover through the latch unit; and
inflating the air inflation sealing unit through the air intake/outtake valve.

7. The sealing method of a wafer carrier of claim 6, further comprising a step of releasing air of the air inflation sealing unit through the air intake/outtake valve.

8. The sealing method of a wafer carrier of claim 6, wherein the air intake/outtake valve comprises a first air intake/outtake passage, a second air intake/outtake passage coupled to the air inflation sealing unit, a central chamber coupled between the first air intake/outtake passage and the second air intake/outtake passage, an O-ring installed in the central chamber and sheathed at a connecting position of the first air intake/outtake passage, and a sealing ball installed at the top of the O-ring.

9. The sealing method of a wafer carrier of claim 8, wherein the air intake/outtake valve performs an inflation in a procedure comprising the steps of:
pushing the sealing ball upward to separate the O-ring by external air through the first air intake/outtake passage; and
entering the external air into the air inflation sealing unit through the first air intake/outtake passage, the central chamber and the second air intake/outtake passage.

10. The sealing method of a wafer carrier of claim 8, wherein the air intake/outtake valve outtakes air in a procedure comprising the steps of:
using a rod shaped object to push the sealing ball into the first air intake/outtake passage and move the sealing ball upward to separate from the O-ring, and interconnect the central chamber with the first air intake/outtake passage; and
discharging the air in the air inflation sealing unit to the outside from the second air intake/outtake passage, the central chamber and the first air intake/outtake passage.
